(19) United States
(12) Patent Application Publication
(10) Pub. No.: US 2006/0080654 A1
(43) Pub. Date: Apr. 13, 2006

(54) Method and apparatus for upgrading implantable medical device operating software

(76) Inventor: Brian M. Shelton, Northridge, CA (US)

Correspondence Address: ARTHUR FREILICH, 9045 CORBIN AVE, #260, NORTHRIDGE, CA, 91324-3343, US

(21) Appl. No.: 11/241,085

(22) Filed: Sep. 30, 2005

Related U.S. Application Data
(60) Provisional application No. 60/617,274, filed on Oct. 9, 2004.

(51) Int. Cl. G06F 9/44

(52) U.S. Cl. 717/173

(57) ABSTRACT

A method and apparatus for reallocating in the local memory of an implantable medical device for upgrading operating software stored in the Code portion of the local memory. The local memory is managed so that new software e.g., a code segment, is accepted into memory provisionally, and then validated before being used to replace existing (i.e., old) software. Each new segment is received in its entirety and its integrity validated before the old software is overwritten. Data log information is downloaded to an external programmer at the start of a software upgrade operation to temporarily free memory space without losing any information. This freed memory space is then reassigned for the purpose of temporarily storing new code segments until they can be received in their entirety and validated. A software copying component is transferred from a local memory code portion to a data portion to allow new code segments to be written into any area of said code portion.

### RELATED APPLICATIONS

This application claims the benefit of U.S. Provisional Application 60/617,274 filed on Oct. 09, 2004 which is incorporated herein by reference.

### FIELD OF THE INVENTION

This invention relates generally to implantable programmable medical devices and more particularly to a method and apparatus which allows such devices to be remotely reprogrammed, e.g., via RF telemetry.

### BACKGROUND OF THE INVENTION

A variety of implantable programmable medical devices are discussed in the literature for use in therapeutic and/or diagnostic applications. For example only, some such devices are used for drug delivery applications, i.e., to infuse a drug at a controlled rate to a specified body site. Other such devices are used to provide controlled electrical pulses for nerve and/or muscle stimulation applications. Regardless of the particular application, it is characteristic of such devices to include a digital controller (e.g., microprocessor) for executing a software program stored in local memory, i.e., memory housed in the implantable device.

It has been recognized that it is beneficial to be able to reprogram such a device, i.e., modify or upgrade the locally stored operating program, without having to remove the device from the patient's body. Such reprogramming is desirable when, for example, a new therapy is developed or a software fault condition needs to be fixed. Various techniques have been described in the prior art for remotely modifying a program stored in an implanted device. In one such prior art approach, code is segmented into two or more different components where one component (bootloader) is used to upgrade the other components but is incapable of itself being upgraded. A disadvantage of this approach is that it requires that a certain portion of local memory be used to store the bootloader which portion is not available for use during normal device operation. For a given size of local memory, this characteristic limits the size of the operating software which could otherwise be available for use by the device. It has also been recognized that the aforedescribed system can be enhanced by utilizing a function or “patch” table that allows functions of the bootloader to be re-used by the operating software. These tables can typically be overwritten such that the functions of the bootloader can be overridden. In other words, a new copy of the function can be placed into a different area of memory with the associated function pointer in the patch table being replaced by a pointer to the new function. In this manner, the functions of the bootloader can be re-used until they need to be upgraded. This design has the limitation that any functions of the bootloader which are upgraded occupy memory space that is not available for use during normal operation. Thus, this characteristic also limits the size of the normal operating software.

### SUMMARY OF THE INVENTION

The present invention is directed to an enhanced method and apparatus for upgrading operating software in the local memory of an implantable medical device (hereinafter frequently referred to as “implant”).

In accordance with the invention, local memory within the implant is reallocated during a software upgrade operation so that new software, e.g., a code segment, can be accepted into memory provisionally, and then validated before being used to replace existing (i.e., old) software. In accordance with preferred embodiments of the invention, each new segment is received in its entirety and its integrity is validated before the old software is overwritten.

It is typical for implantable medical devices to keep data logs in local memory containing a history of medical and/or diagnostic events. In accordance with the present invention, data log information is uploaded to an external programmer at the start of a software upgrade operation to temporarily free memory space without losing any information. This freed memory space is then reassigned for the purpose of temporarily storing new code segments until they can be received in their entirety and validated. Only after validation is the new segment used to replace existing (i.e., old) stored software.

In accordance with a preferred embodiment of the invention, implant local memory is partitioned into three functionally distinct areas which are reallocated to execute the software upgrade operation. The areas include a Code memory (where operating software code normally resides for execution), a Log memory (normally used to log event data but reallocated to temporarily store new software prior to its validation), and a Data memory (normally used to store program variables but reallocated to temporarily store a software copying component which is executed to copy new software from the Log memory to Code memory to replace old software). Code memory and Log memory are preferably implemented with nonvolatile memory devices, e.g., FLASH or EEPROM. Data memory can be implemented in RAM.

In the preferred embodiment, any code segment in the Code Memory can be overwritten if there is a free block of Log memory sufficiently large to hold the segment and if an area of Data memory can be made available to hold a software copying component, or module. This software copying component defines a routine for (1) reading a block of code from Log memory, (2) writing the code to Code memory, and (3) resetting the implant controller. The software copying component can thus function to overwrite any portion of the Code memory because it executes from Data memory where the program variables and the operating software stack normally reside.

The software copying component need have only limited functionality and does not require as much Data memory space for variables and stack as does the operating software. Therefore, Data memory space can be readily reallocated to accommodate the software copying component during the software upgrade operation.

A preferred software upgrade operation in accordance with the invention includes the following steps:
1. Pause execution of the operating software and the therapy currently being administered by the implant.
2. Reallocate the Log memory to accept the new software segment.
3. Receive the new code segment via telemetry and write it to the Log memory.
4. Validate the segment
5. If the segment is valid,
   A. Turn off the telemetry transceiver and cease telemetry.
   B. Reallocate the Data memory to accept the software copying component.
   C. Copy or move the software copying component to the Data memory.
   D. Execute the software copying component from Data memory
   E. Reset the implant controller, or restart the software.

If the software segment is not valid, mark it as invalid.

### BRIEF DESCRIPTION OF THE FIGURES

FIG. 1 is a block diagram of an exemplary medical system comprised of an implanted medical device and an external programmer;

FIG. 2 is a block diagram depicting the normal operation of a preferred medical device memory organized into Code, Log, and Data portions in accordance with the present invention;

FIG. 3 is a diagram depicting an exemplary sequence of communications between the external programmer and implanted medical device which occur in the performance of a software upgrade operation in accordance with the invention;

FIGS. 4-9 depict the manner in which the preferred medical device memory is managed to implement the steps of an upgrade operation in accordance with the invention wherein:
FIG. 4 depicts the step of uploading event log data;
FIG. 5 depicts the step of downloading start or segment messages;
FIG. 6 depicts the step of downloading a code message for temporary storage in the Log memory;
FIG. 7 depicts the step of validating the code segment bytes temporarily stored in Log memory;
FIG. 8 depicts the step of moving the software copying component from Code to Data memory for execution;
FIG. 9 depicts the step of writing the validated software segment into Code memory to replace an old segment; and

FIG. 10 comprises a flow chart depicting the sequence of actions involved in executing the software upgrade operation in accordance with a preferred embodiment of the invention.

### DETAILED DESCRIPTION

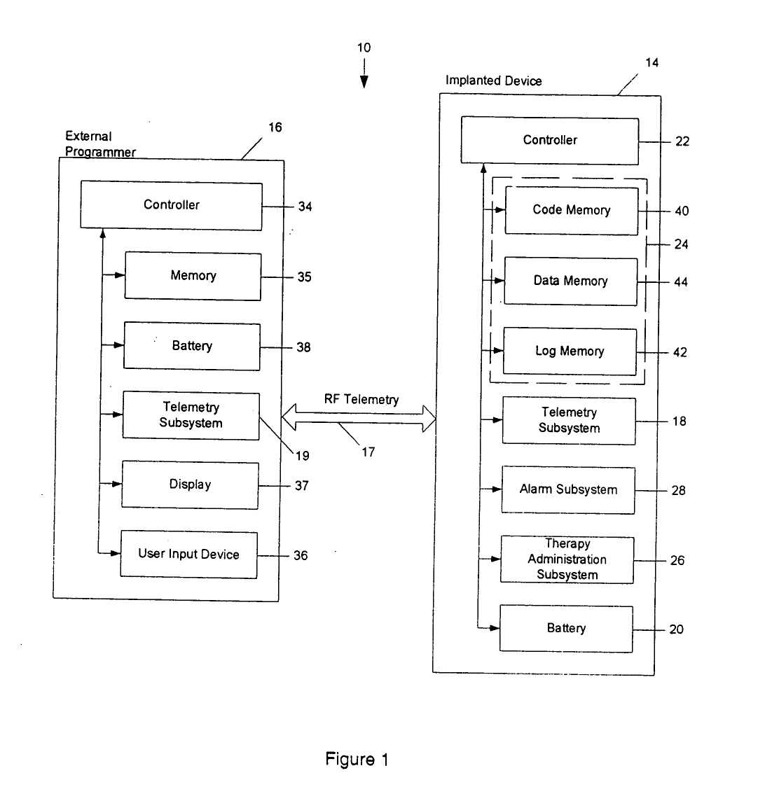

Attention is initially directed to FIG. 1 which presents a generalized block diagram of a medical system 10 comprised of at least one implantable medical device 14 and an external communication device or programmer 16. The system of FIG. 1 is configured to enable the medical device 14 and the programmer 16 to communicate, e.g., via RF telemetry 17, using telemetry subsystem 18 and telemetry subsystem 19, respectively contained within the devices 14 and 16. Although the medical device 14 can comprise any one of a variety of devices for administering different types of therapies, unless otherwise stated, the exemplary medical device 14 referred to herein will be assumed to comprise an infusion pump which is implanted in a patient's body for the purpose of delivering a fluid drug to a body site. The programmer 16, on the other hand, is intended to be deployed external to the body and available for use by a physician or clinician to transmit control and/or data signals to the device 14.

The implanted medical device 14 functions in accordance with stored software defining an operating program for administering a certain therapy based on data stored in the device, e.g., a drug delivery profile. In normal usage, a clinician is able to use the programmer to produce signals which are transmitted via RF link 17 to the medical device 14 to affect its therapeutic performance such as by modifying its stored operating program and/or drug delivery profile. Systems of the type depicted in FIG. 1, as thus far described, are commercially available and generally well known. The present invention is primarily directed to a method and apparatus particularly configured to permit the software stored in the device 14 to be modified to, for example, upgrade the operating program or correct software faults.

As depicted in FIG. 1, a typical medical device 14 in system 10 includes an internal power source 20, e.g., a battery, a controller 22 (e.g., a microprocessor or microcontroller), and a local or internal memory 24 associated therewith for storing programs and/or data. The controller 22 operates to execute a stored program to control a therapeutic administration subsystem 26 which can, for example, controllably deliver a drug to a patient's body site. The device 14 may also include an alarm subsystem 28 to alert the patient or clinician of some monitored event.

Programmer device 16 is shown as including a controller 34 (e.g., a microprocessor or microcontroller) which operates in conjunction with memory 35 which stores programs and/or data. The device 16 optionally includes a user input device 36, e.g., a keyboard, and a user output device 37, e.g., a display. The programmer 16 further includes aforementioned telemetry subsystem 19 configured to transmit signals to or receive signals from the medical device telemetry subsystem 18. The programmer 16 may further include an internal power source 38 which can comprise a battery or any other suitable conventional power source.

In a typical system 10, the programmer 16 is capable of sending messages to the medical device 14 for use by controller 22 to affect the operation of its therapeutic administration subsystem 26. Additionally, the medical device 14 is typically capable of sending messages to the communication device 16 to report various conditions, e.g., battery status; drug reservoir status, etc. These respective messages sent by the programmer 16 and medical device 14 are handled by the respective telemetry subsystems 19 and 18, each of which is able to transmit and receive RF telemetry signals. Typically, these RF telemetry signals comprise bit streams carried by an RF carrier signal of specified frequency.

The present invention is particularly directed to a memory management system for reallocating local memory 24 in a manner which permits the external programmer 16 to modify software stored in the memory 24 without compromising the efficiency of the memory in its normal functioning to control the therapy administration subsystem 26. In a preferred embodiment of the invention, the local memory 24 is comprised of three functionally distinct areas, i.e., a Code memory portion 40, a Log memory portion 42, and a Data memory portion 44. The Code and Log memory portions are preferably implemented with nonvolatile memory devices, e.g., FLASH or EEPROM. The Data memory can be implemented with conventional RAM.

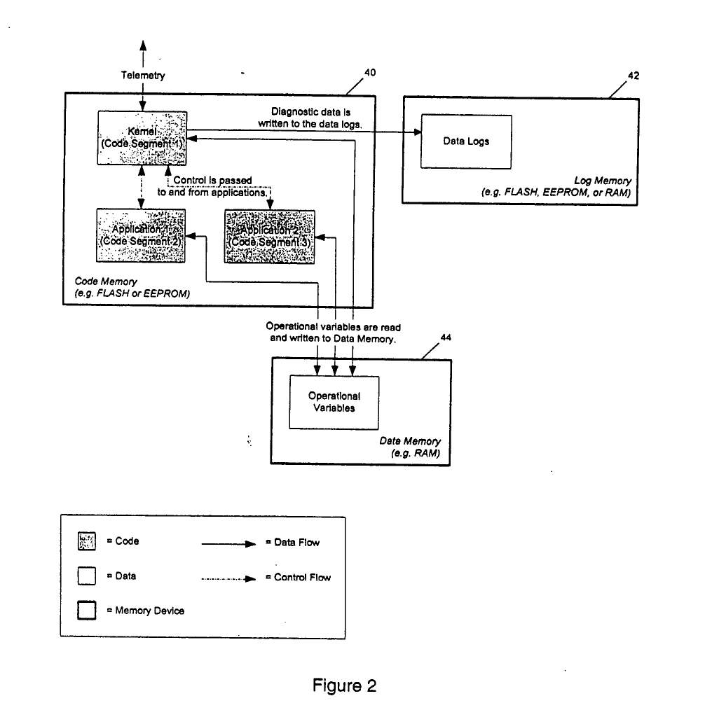

FIG. 2 generally illustrates the organization and functionality of the memory portions 40, 42, 44 in the normal operation of the device 14 for therapy administration. The controller 22 normally operates in conjunction with Code memory 40 to execute kernel and application software which define an operating program. The controller 22 normally executes the kernel software (e.g., code segment 1) which periodically passes control to the application software (e.g., code segments 2, 3) when appropriate. Execution of the kernel and application software typically involves bidirectional data flow with the Data memory 44 which is normally used to store operational variables. In executing the kernel and application software, event data, e.g., diagnostic and archival data, are preferably stored in data logs in Log memory 42.

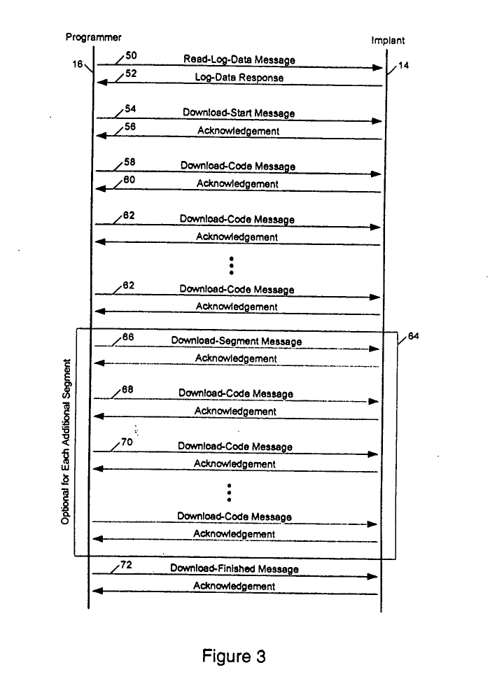

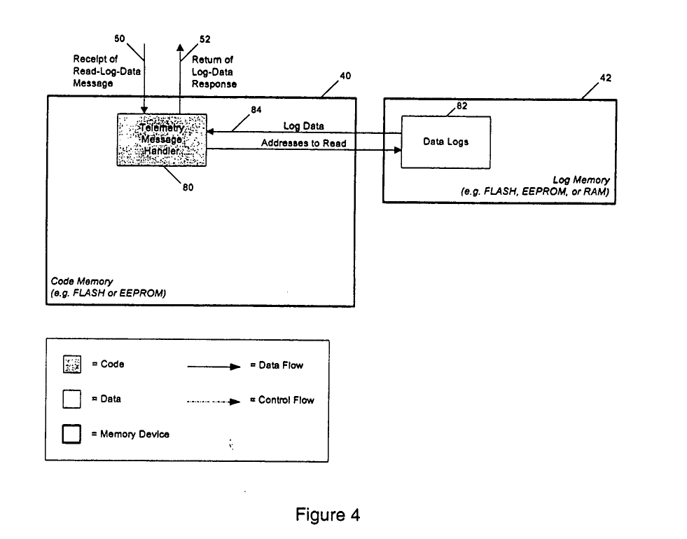

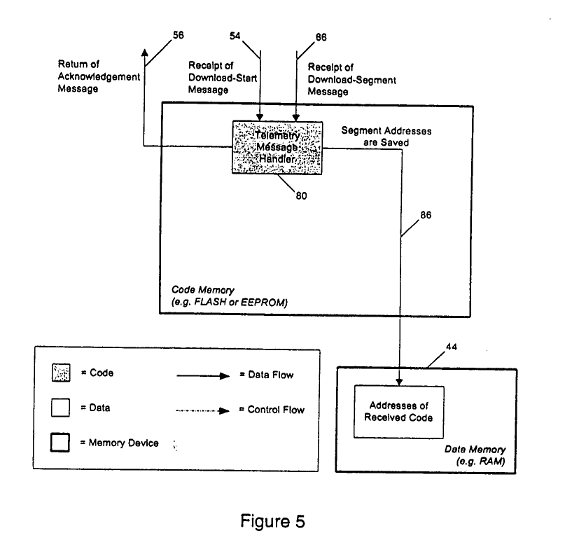

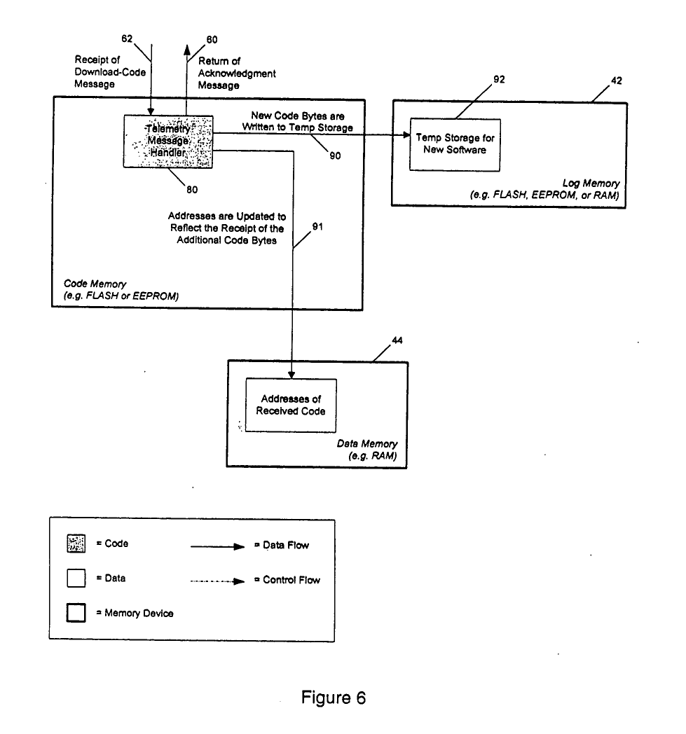

Attention is now directed to FIG. 3 which depicts an exemplary sequence of communications between the external programmer 16 and implanted medical device 14 utilized in the performance of a software upgrade operation in accordance with the invention. The initial communication shown is a read-log-data message 50 sent by the programmer 16 to the implanted medical device 14 (hereinafter frequently referred to as the “implant”). The implant will provide a log-data response 52 to acknowledge the message. As will be discussed hereinafter, the consequence of this exchange is to cause the data-log contents in Log memory 42 to be uploaded to the programmer for temporary storage during the software upgrade operation.

Thereafter, a download-start message 54 is provided by the programmer 16 with the implant providing an acknowledgement 56. The download start message includes address information identifying the start location in Code memory of the software segment to be upgraded. Thereafter, programmer 16 provides communication 58 comprising the code bytes of the new software segment to be written into Code memory to upgrade, i.e., replace an old software segment. The message 58 is acknowledged at 60. Additional download-code messages 62, etc. are communicated from the programmer to the implant until all of the segment code bytes have been transferred. Thereafter, an additional segment can be transferred from programmer 16 to implant 14 as represented by the sequence in block 64. The block 64 sequence is initiated by a download-segment message 66 which includes address information identifying the start location in Code memory in which the new software segment is to be written. Thereafter, the data, i.e., code bytes are communicated in successive blocks, i.e., download-code messages 68, 70, etc. After all the software segments, and their code byte content, have been communicated from the programmer 16 to the implant 14, a download-finished message 72 is communicated to end the software upgrade operation. The actions initiated by the messages communicated in FIG. 3 are represented in greater detail in FIGS. 4-9 which will be discussed hereinafter.

Attention is now directed to FIGS. 4-9 which illustrate control and data flow within local device memory 24 which occurs as a consequence of the various messages shown in FIG. 3 communicated from the programmer 16 to the implant 14 in the course of performing a software upgrade operation. More particularly, FIG. 4 depicts activity in the memory 24 in response to the implant 14 receiving the read-log-data message 50. A telemetry message handler 80 within code memory 40 responds to the read-log-data message to address locations in Log memory 42 identified by the received message 50. These locations are represented in FIG. 4 as a data log block 82. As a consequence, log data 84 is returned to the message handler 80 for upload (response 52) to the programmer 16. The controller then halts operations which utilize the freed Log memory space.

FIG. 5 illustrates data flow in memory 24 in response to receipt of a download start message 54 or a download segment message 66. In either case, the message handler 80 responds with an acknowledgement message 56. Additionally, the message handler uses the address information embedded in the received message 54 or 66 to address identified locations in the data memory 44. Thereafter, as depicted in FIG. 6, a subsequently received download code message 62, containing code bytes, is handled by the message handler 80. The received new code bytes 90 are written into temporary storage 92 within Log memory 42. Additionally, the message handler 80 updates the address information with respect to the Data memory 44 to reflect the receipt of the new code bytes. Further, the message handler 80 returns an acknowledgement message 60.

FIG. 7 depicts activity in response to receipt of a download-finished message 72. The message handler 80 responds to initiate execution 94 of a software validation component 96 in Code memory 40. The software validation component 96 examines the new code bytes stored in temporary storage 92 in the locations identified by address information 98 in Data memory 44. The software validation component 96 determines whether a segment, and/or code bytes thereof, are valid and communicates a pass/fail decision back to message handler 80 via path 100.

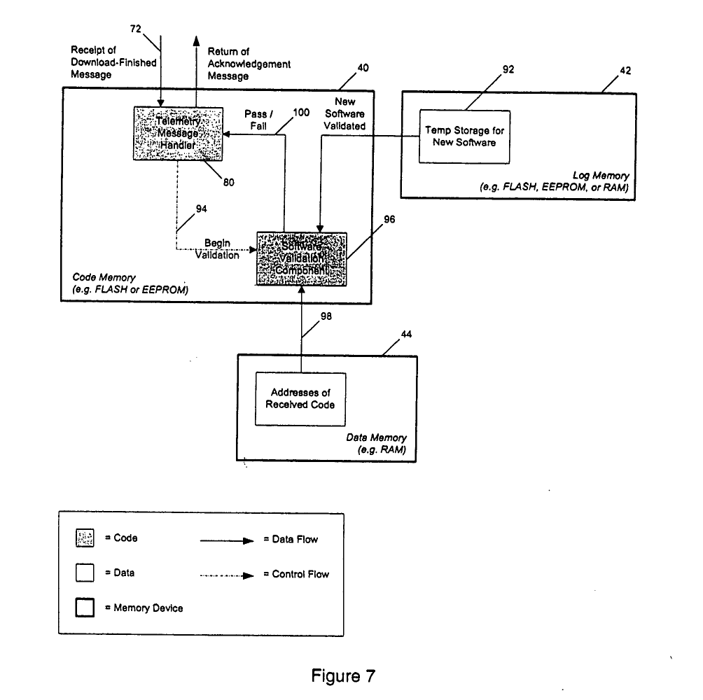

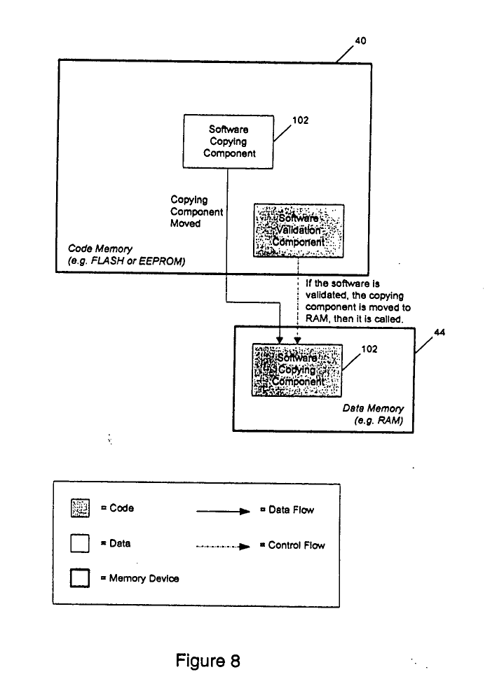

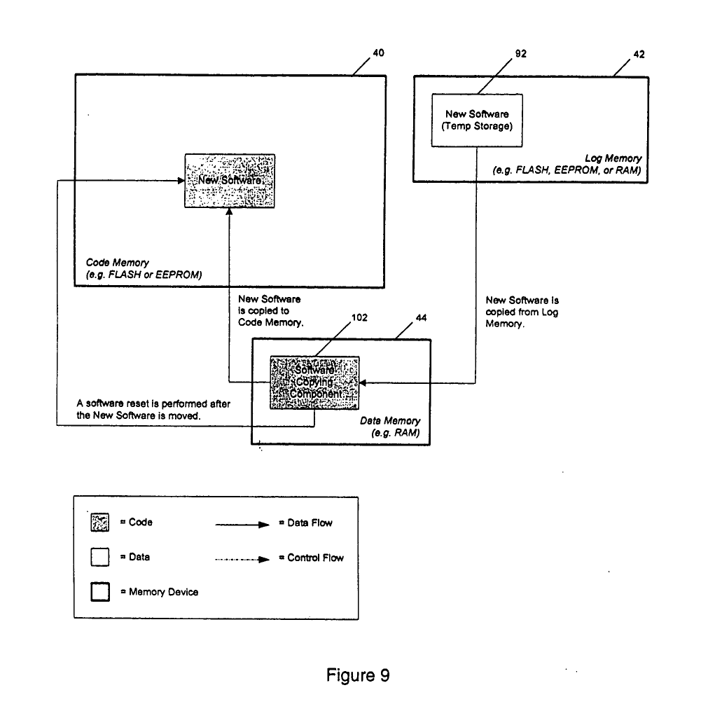

FIG. 8 shows the movement of the software copying component 102 from Code memory 40 to Data memory 44. If in FIG. 7, a software validation component 96 validates a software segment, and/or code bytes, it is then processed by the software copying component 102 within Data memory 44. This is depicted in FIG. 9 wherein the new software code bytes temporarily stored in Log memory 42 are processed by the software copying component 102 in Data memory 44. The software copying component is executed from Data memory 44 and functions to copy the new software from the temporary storage 92 to the Code memory 40.

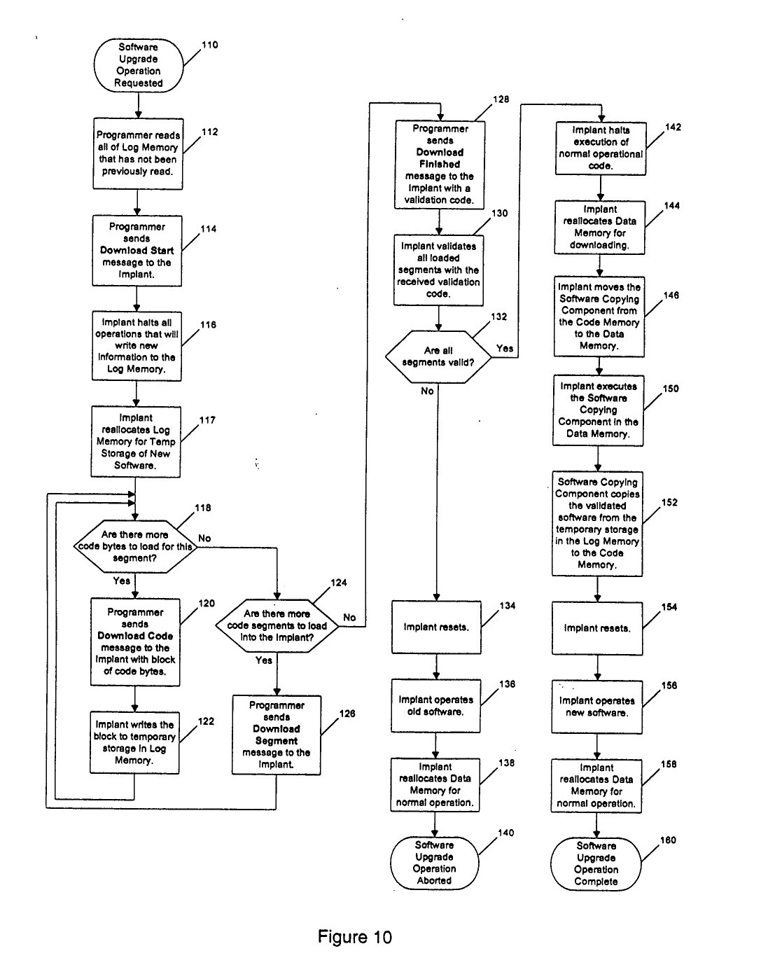

Attention is now directed to FIG. 10 which comprises a flow chart depicting the overall sequence of steps involved in performing the software upgrade operation in accordance with the preferred embodiment of the invention. The software upgrade operation is initiated by request 110. Block 112 represents the programmer 16 reading data from the Log memory 42, as previously described in connection with FIG. 4, to free space in the Log memory. Block 114 represents the programmer sending a download start message 54 to the implant 14. Block 116 then halts all operations that would cause new information to be written into Log memory 42 and block 117 reallocates the freed Log memory space for temporary storage. Decision block 118 then asks, are there more code bytes in the current segment to be loaded into the log memory? If YES, the programmer sends a download code message to the implant containing a block of code bytes (block 120). In block 122, the implant 14 writes the block of code bytes to temporary storage in the Log memory as has been previously described in connection with FIG. 6. Operation then loops back to decision block 118.

If decision block 118 produces a NO response, then decision block 124 is executed and asks are there any more code segments to load into the implant. If YES, operation proceeds to block 126 where the programmer sends a download-segment message to the implant prior to looping back to decision block 118.

If decision block 124 produces a NO response, operation proceeds to block 128. In block 128 the programmer 16 sends a download-finished message 72 to the implant 14 with a validation code, as depicted in FIG. 7. In block 130, the implant 14 determines the validity of segments temporarily stored in Log memory 42, using the received validation code. Block 132 then asks, are all segments valid? If NO, then the implant in block 134 resets to a default condition and continues to operate executing old operating software (block 136). The implant reallocates data memory for normal operation (block 138) and the software upgrade operation is aborted (block 140).

On the other hand if decision block 132 produces a YES response, operation proceeds to block 142. In block 142 the implant 14 halts the execution of normal, or old, operating code. In block 144, the implant reallocates Data memory for downloading. In block 146, the implant moves the software copying component from the Code memory to the Data memory, as was previously described in connection with FIG. 8. In block 150, the implant executes the software copying component in Data memory and in block 152 the software copying component copies the validated software from the temporary storage in Log memory to Code memory, as was described with respect to FIG. 9. In block 154, the implant 14 resets for normal operation to now execute the operating software newly loaded into Code memory 40, as represented by block 156. In block 158 the implant 14 reallocates data memory for normal operation. Block 160 completes the software upgrade operation.

From the foregoing, it should now be understood that a system utilizing an implantable medical device has been described herein which allows full utilization of the device local memory capacity during normal operations but which permits reallocation of the memory for the purpose of performing a software upgrade operation. The software upgrade operation enables any segment of the stored operating software to be replaced, e.g., overwritten, in Code memory.

Although a specific preferred embodiment has been described herein, it should be understood that various modifications and alternatives may occur to those skilled in the art falling within the spirit of the invention and the intended scope of the appended claims.

1. A medical system comprising:
an implantable medical device including a local implant memory for storing implant operating software and an implant controller normally operable to execute a therapy administration program defined by said implant operating software;
an external programmer including a local programmer memory and a programmer controller for communicating with said implant controller for modifying said implant operating software; and wherein
said local implant memory includes a Code memory normally operable for storing implant operating software executable by said implant controller, a Log memory normally operable for logging event data, and a Data memory normally operable for storing variables used by said implant operating software; and wherein
said programmer controller is operable to initiate an implant software upgrade procedure by reallocating said implant memory including means for freeing space in said Log memory and means operable to download new code segments from said programmer memory for temporary storage in said space freed in said Log memory; and wherein
said implant controller includes means for validating each such new code segment downloaded from said programmer memory, means operable to transfer a software copying component from said Code memory to said Data memory, and means for executing said software copying component from said Data memory for writing validated code segments into said Code memory.

2. The system of claim 1 wherein said Code memory and/or said Log memory utilize non volatile memory devices.

3. The system of claim 1 further including means for reallocating said implant memory for normal operation to execute operating software from said Code memory.

4. The system of claim 1 wherein said means for freeing space in said Log memory includes means for temporarily uploading event data from said Log memory to said programmer memory.

5. The system of claim 4 further including means for downloading to said Log memory event data previously uploaded to said programmer memory for restoring said Log memory for normal operation.

6. A medical system comprising:
an implantable medical device including a local device memory for storing operating software comprised of one or more code segments and a controller for executing a therapy administration program defined by said operating software;
an external programmer including local programmer memory and a controller for controlling information read from and written into said local programmer memory;
telemetry means for supporting bidirectional communication between said medical device and said external programmer; and wherein
said external programmer is operable to initiate a procedure for modifying said operating software stored in said local device memory, said procedure including means for initially freeing space in said local device memory by temporarily uploading data therefrom to said local programmer memory, means for downloading code segments from said local programmer memory to said space freed in said local device memory, means for validating each such downloaded code segment, and means for replacing a previously stored code segment with a validated code segment.

7. The system of claim 6 wherein said local device memory includes a Code memory portion normally operable for storing operating software executable by said medical device controller and a Data memory portion normally operable for storing data used by said operating software; and wherein
said procedure for modifying said operating software involves transferring a software copying component from said Code memory to said Data memory for execution by said medical device controller to enable any portion of said Code memory to be modified.

8. A medical system comprising:
an implantable medical device having operating software stored in a local device memory and controller means normally operable to execute said operating software to administer a certain medical therapy;
an external programmer configured to initiate an upgrade procedure to replace old code segments of said operating software with new code segments downloaded by said programmer to said medical device;
means initially effective during said procedure for interrupting the normal operation of said medical device controller and for uploading event log information from said local device memory to said external programmer to free space in said local device memory;
means for temporarily storing a downloaded code segment in said freed space in said local device memory;
means for determining the validity of said temporarily stored code segment;
means for replacing a code segment of said stored operating software in said local device memory with a validated code segment;
means for downloading said previously uploaded event log information to restore said information in said local device memory; and
means for resuming normal operation of said medical device.

9. The system of claim 8 wherein said local device memory includes a Code memory portion normally operable for storing operating software executable by said medical device controller and a Data memory portion normally operable for storing data used by said operating software; and wherein
said procedure for modifying said operating software involves transferring a software copying component from said Code memory to said Data memory for execution by said medical device controller to enable any portion of said Code memory to be modified.

10. A method of upgrading operating software stored in the local memory of an implantable medical device comprising:
uploading stored information from said medical device local memory to an external processor to create free space in said memory;
downloading code segments from said external processor for temporary storage in said local memory free space;
determining whether each of said temporarily stored code segments is valid;
storing each of said code segments determined to be valid in said medical device local memory in place of a previously stored code segment; and
downloading to said medical device local memory said information previously uploaded to said external processor.

11. The method of claim 10 including:
partitioning said local memory into a Code memory and a Log memory; and wherein
said step of uploading stored information creates free space in said Log memory.

12. The method of claim 11 wherein said step of downloading code segments includes temporarily storing said code segments in said Log memory.

13. The method of claim 11 wherein said step of storing code segments determined to be valid includes storing valid code segments in said Code memory.

14. The method of claim 10 wherein said Code memory and/or said Log memory comprise non volatile memory devices.

15. The method of claim 10 further including:
partitioning said local memory into a Code memory, a Log memory, and a Data memory; and
transferring a software copying component from said Code memory to said Data memory for execution to cause code segments determined to be valid to be written into said Code memory.

16. The method of claim 15 including responding to code segments read from said Code memory for controlling said medical device.

17. A method of modifying operating software stored in a Code portion of a local memory of an implantable medical device comprising:
uploading information from a Log portion of said local memory to an external programmer to free space in said Log portion;
downloading new operating software code segments from said external programmer for temporary storage in said Log portion;
determining whether each of said new code segments temporarily stored in said Log portion is valid;
transferring a software copying component from said Code portion to a Data portion of said local memory; and
executing said software copying component from said Data portion to store code segments determined to be valid in said Code portion.

18. The method of claim 17 wherein said steps of uploading and/or downloading includes a step of wirelessly transmitting information between said local memory and said external programmer.

19. The method of claim 17 further including responding to code segments read from said Code memory for controlling said medical device.

20. The method of claim 17 wherein said Code memory and/or said Log memory comprises a non volatile memory device.
